(19) United States
(12) Patent Application Publication
(10) Pub. No.: US 2015/0063926 A1
(43) Pub. Date: Mar. 5, 2015

(54) INDEXABLE CUTTING INSERT WITH COOLANT DELIVERY

(71) Applicant: Kennametal Inc., Latrobe, PA (US)

(72) Inventors: Qiang Wu, North Huntingdon, PA (US); Christoph Gey, Zirndorf (DE); Horst M. Jaeger, Nurnberg (DE); Michael A. Weisel, Latrobe, PA (US); Nicholas J. Henry, Greensburg, PA (US)

(73) Assignee: Kennametal Inc., Latrobe, PA (US)

(21) Appl. No.: 14/014,668

(22) Filed: Aug. 30, 2013

(51) Int. Cl. B23B 27/10; B23B 51/06; B23B 27/16

(52) U.S. Cl. CPC B23B 27/10; B23B 27/1651; B23B 51/06; B23B 2200/049; B23B 2200/0447; B23B 2200/3618; B23B 2200/3627; B23B 2200/086; B23B 2250/12; B23B 2251/50
USPC 407/11

(57) ABSTRACT

An indexable cutting insert includes a rake face, a flank surface, a bottom surface, and a central aperture defined by an aperture side wall. The indexable cutting insert further has a mouth defined by a mouth surface. There is a primary coolant trough that has an aperture section in the side wall contained in the aperture side wall, a mouth section contained in the mouth surface, and a rake face section contained in the rake face. There is a radial angular coolant trough, which has an entrance end opening into a selected one of the primary coolant trough and the mouth. The radial angular coolant trough has an orientation wherein the central longitudinal axis thereof is generally perpendicular to a corresponding discrete cutting edge whereby during operation a coolant stream is directed toward the corresponding discrete cutting edge.

### BACKGROUND

The present invention pertains to an indexable cutting insert with a coolant delivery feature. Further, the invention pertains to an indexable cutting insert that has a coolant delivery feature and is suitable for use in a drill body of an indexable drill assembly, which is useful for the drilling of holes in a workpiece. More specifically, the invention pertains to an indexable cutting insert, which is suitable for use in a drill body of the indexable drill assembly, adapted to facilitate enhanced delivery of coolant adjacent the interface between the workpiece and the indexable cutting insert (insert-chip interface). The delivery of coolant provides cooling thereby diminishing tremendous heat and also providing lubrication at the insert-chip interface in an operation such as, for example, a hole drilling operation.

Indexable drill assemblies useful for the drilling of holes in a workpiece generally include an outboard cutting insert and an inboard cutting insert wherein each cutting insert has a surface terminating at a cutting edge. The indexable drill further includes a tool holder formed with a seat adapted to receive the insert. Each cutting insert engages a workpiece to remove material, and in the process forms chips of the material. Excessive heat at the insert-chip interface can negatively impact upon (i.e., reduce or shorten) the useful tool life of each cutting insert.

For example, a chip generated from the workpiece can sometimes stick (e.g., through welding) to the surface of the cutting insert. The build up of chip material on the cutting insert in this fashion is an undesirable occurrence that can negatively impact upon the performance of the cutting insert, and hence, the overall drilling operation. A flow of coolant to the insert-chip interface will reduce the potential for such welding. It would therefore be desirable to reduce excessive heat at the insert-chip interface to eliminate or reduce build up of chip material.

As another example, in a chipforming drilling operation, there can occur instances in which the chips do not exit the region of the insert-chip interface when the chip sticks to the cutting insert. When a chip does not exit the region of the insert-chip interface, there is the potential that a chip can be re-cut. It is undesirable for the cutting insert to re-cut a chip already removed from the workpiece. A flow of coolant to the insert-chip interface will facilitate the evacuation of chips from the insert-chip interface thereby minimizing the potential that a chip will be re-cut during the drilling operation.

There is an appreciation that a shorter useful tool life increases operating costs and decreases overall production efficiency. Excessive heat at the insert-chip interface contribute to the welding of chip material and re-cutting of chips, both of which are detrimental to production efficiency. There are readily apparent advantages connected with decreasing the heat at the insert-chip interface wherein one way to decrease the temperature is to supply coolant to the insert-chip interface.

Heretofore, cutting inserts useful in material removal applications have provided for the delivery of coolant to the region of the insert-chip interface. The following patent documents are exemplary of some earlier efforts.

U.S. Pat. No. 6,123,488 to Kasperik et al. pertains to a cutting insert that contains a central aperture defined by an aperture wall. In the Kasperik et al. patent, the aperture wall contains protrusions that function to assist the operator to identify the specific cutting insert. U.S. Pat. No. 7,198,437 to Jonsson (also U.S. Reissue Pat. No. Re 42,644 E) discloses a round cutting insert-round shim assembly. The bottom surface of the cutting insert contains radial indexing portions and the top surface contains swirled chip breakers. U.S. Pat. No. 7,677,842 to Park shows a cutting insert that contains a central aperture defined by a wall. The wall has clearance portions that render the aperture non-circular.

United States Patent Application Publication No. US 2001/0027021 to Nelson et al. shows a round cutting insert that includes a base member having central aperture wherein a core member is in the central aperture. An interior coolant passage is defined between the core and the surface that defines the central aperture. United States Patent Application Publication No. US2009/0123244 to Beuttiker et al. pertains to a machine reamer that includes coolant flow passages around a screw (34) with the flow of coolant (apparently indicated by the arrows 78) in a coolant bore (66). See FIG. 1d.

U.S. Pat. No. 7,997,832 B2 to Prichard et al. discloses a cutting insert that contains interior coolant channels for delivery of coolant to the vicinity of the intersection of the cutting insert and the workpiece. In one embodiment, the cutting insert comprises a diverter plate that attaches to a milling insert body (e.g., see FIG. 7). In another embodiment, a milling insert body receives opposite rake plates (e.g., see FIG. 16). In still another embodiment, a milling insert body receives a milling rake plate (e.g., see FIGS. 19-22).

U.S. Pat. No. 7,125,207 to Craig et al. discloses a tool holder that carries cutting inserts. The tool holder contains an integral coolant channel. The integral coolant channel provides for the delivery of coolant to the cutting inserts. United States Patent Application Publication No. US 2011/0229277 A1 to Hoffer et al., and assigned to Kennametal Inc. (the assignee of the present invention) discloses a round cutting insert that includes distinct interior coolant passages that provide for the flow of coolant to the cutting edge of the insert. In one embodiment, the round cutting insert includes a base member that receives a core member. The distinct interior coolant passages are defined between the base member and the core member.

United States Patent Application Publication No. US2011/0020072 to Chen et al. shows a cutting insert and a cutting insert-shim assembly. The cutting insert contains a plurality of distinct coolant passages. The shim contains an opening that facilitates coolant flow to the cutting insert. United States Patent Application Publication No. US2010/00272529 to Rozzi et al. shows a rotary cutting tool in which there is coolant delivery to the pocket regions thereof. An integral cooling channel branches into a direct cooling channel in communication with a jet opening ad an indirect cooling channel that has an opening in the tool pocket. U.S. Pat. No. 6,595,727 B2 to Arvidsson shows a tool for chip-removing machining that provides coolant to a plurality of the cutting inserts via fluid-conducting grooves.

U.S. Pat. No. 5,346,335 to Harpaz et al. shows a cutting insert with a recessed portion. A through-going bore extends through the cutting insert including in the vicinity of the recessed portion. Coolant flows through the through-going bore to provide coolant to the cutting insert. Japanese Patent Application Publication JP 5-301104 (assigned to Sumitomo Electric Ind. Ltd.) shows a cutting insert that contains a plurality of interior cooling channels.

United States Patent Application Publication No. US 2011/0020077 to Fouqyer shows a hollow clamping screw having an axial channel that carries lubricating fluid. The fluid apparently sprays on the cutting insert (e.g., see FIG. 9).

### SUMMARY OF THE INVENTION

In one form thereof, the invention is an indexable cutting insert that comprises a rake face, a flank surface, and a bottom surface. The indexable cutting insert contains a central aperture that has a top aperture end and is defined by an aperture side wall. The indexable cutting insert further has a mouth defined by a mouth surface. There is a primary coolant trough that has an aperture section contained in the aperture side wall and the aperture section has an aperture section bottom surface. The primary coolant trough also has a mouth section contained in the mouth surface and the mouth section has a mouth section bottom surface. The primary coolant trough further has a rake face section contained in the rake face and the rake face section has a rake face section bottom surface. The indexable cutting insert has a radial angular coolant trough that has an entrance end opening into a selected one of the primary coolant trough and the mouth. The radial angular coolant trough has a central longitudinal axis. The radial angular coolant trough has an orientation wherein the central longitudinal axis is generally perpendicular to a corresponding discrete cutting edge whereby during operation a coolant stream is directed toward the corresponding discrete cutting edge.

In still another form thereof, the invention is an indexable cutting insert adapted to be retained in a pocket, which has a seating surface, of an indexable drill body. The indexable drill body contains a pocket coolant channel opening at the seating surface. The indexable drill body further contains a retention screw aperture opening in the seating surface. The seating surface contains a coolant ring surrounding the retention screw aperture wherein the coolant ring is in fluid communication with the pocket coolant channel. The indexable cutting insert comprises a rake face, a flank surface, and a bottom surface. The indexable cutting insert contains a central aperture. The indexable cutting insert further contains an annular groove in the bottom surface surrounding the central aperture adjacent an central aperture bottom end thereof. The annular groove cooperates with the coolant ring to form a circular coolant conduit through which coolant flows from the pocket coolant channel to the indexable cutting insert.

### BRIEF DESCRIPTION OF THE DRAWINGS

The following is a brief description of the drawings that form a part of this patent application:

FIG. 1 is an isometric view of a specific embodiment of the indexable drill assembly along with a workpiece;

FIG. 2 is an isometric view of the outboard pocket of the indexable drill body without an outboard cutting insert within the outboard pocket;

FIG. 3 is an isometric view of the inboard pocket of the indexable drill body without an inboard cutting insert within the inboard pocket;

FIG. 4. is an isometric view of the indexable outboard cutting insert showing the rake surface of the indexable outboard cutting insert;

FIG. 4A is an isometric view of one outboard primary coolant trough of the outboard cutting insert;

FIG. 5. is an isometric view of the outboard cutting insert showing the bottom surface of the outboard cutting insert;

FIG. 6. is an isometric view of the indexable inboard cutting insert showing the rake surface of the indexable inboard cutting insert;

FIG. 6A is an isometric view of one inboard primary coolant trough of the inboard cutting insert;

FIG. 7. is an isometric view of the inboard cutting insert showing the bottom surface of the inboard cutting insert;

FIG. 8 is an isometric view of the outboard retention screw;

FIG. 9 is a side view of the outboard retention screw;

FIG. 10 is an isometric view of the inboard retention screw;

FIG. 11 is a side view of the inboard retention screw;

FIG. 12 is an isometric view of the outboard cutting insert received within the outboard pocket of the indexable drill body, but without the outboard retention screw in position;

FIG. 13 is an isometric view of the outboard cutting insert received within the outboard pocket of the indexable drill body wherein the outboard retention screw secures the outboard cutting insert in position in the outboard pocket;

FIG. 13A is a cross-sectional view of the outboard cutting insert received within the outboard pocket of the indexable drill body of FIG. 13 taken along section line 13A-13A of FIG. 13;

FIG. 14 is an isometric view of the inboard cutting insert received within the inboard pocket of the indexable drill body, but without the inboard retention screw in position;

FIG. 15 is an isometric view of the inboard cutting insert received within the inboard pocket of the indexable drill body wherein the inboard retention screw secures the inboard cutting insert in position in the inboard pocket;

FIG. 15A is a cross-sectional view of the inboard cutting insert received within the outboard pocket of the indexable drill body of FIG. 15 taken along section line 15A-15A of FIG. 15;

FIG. 16 is an isometric schematic view showing the flow of coolant through the axial forward portion of the indexable drill body and into the outboard pocket and then into the indexable outboard cutting insert;

FIG. 17 is a schematic top view showing the coolant flow out of the outboard cutting insert when secure din the outboard pocket;

FIG. 18 is an isometric schematic view showing the flow of coolant through the axial forward portion of the indexable drill body and into the inboard pocket and then into the inboard cutting insert;

FIG. 19 is a schematic top view showing the coolant flow out of the inboard cutting insert;

FIG. 20 is an isometric view of another specific embodiment of a rectangular cutting insert;

FIG. 20A is an isometric view of one outboard primary coolant trough of the cutting insert of FIG. 20;

FIG. 21 is an isometric view of the cutting insert of FIG. 20 showing the bottom surface of the cutting insert; and

FIG. 22 is a top view of the cutting insert of FIG. 20 showing the rake surface of the inboard cutting insert.

### DETAILED DESCRIPTION

As described hereinabove, the present invention pertains to an indexable drill assembly, as well as the drill body of the indexable drill assembly, useful for the drilling of holes in a workpiece. More specifically, the invention pertains to an indexable drill assembly, as well as the drill body of the indexable drill assembly, useful for the drilling of holes in a workpiece adapted to facilitate enhanced delivery of coolant adjacent (or proximate) the interface between the workpiece and each one of the outboard cutting insert and the inboard cutting insert (insert-chip interface) so as to provide cooling thereby diminishing tremendous heat and also providing lubrication at the insert-chip interface in a hole drilling operation. Delivery of coolant to the insert-chip interface is especially beneficial in drilling long-chipping materials, such as, for example, low carbon steel, stainless steel, and high temperature alloys.

Excessive heat at the insert-chip interface contribute to the welding of chip material and re-cutting of chips, both of which are detrimental to production efficiency. There is an appreciation that a shorter useful tool life increases operating costs and decreases overall production efficiency. It therefore becomes readily apparent that there are advantages connected with decreasing the heat due to high cutting temperatures at the insert-chip interface wherein one way to decrease the temperature is to supply coolant to the insert-chip interface.

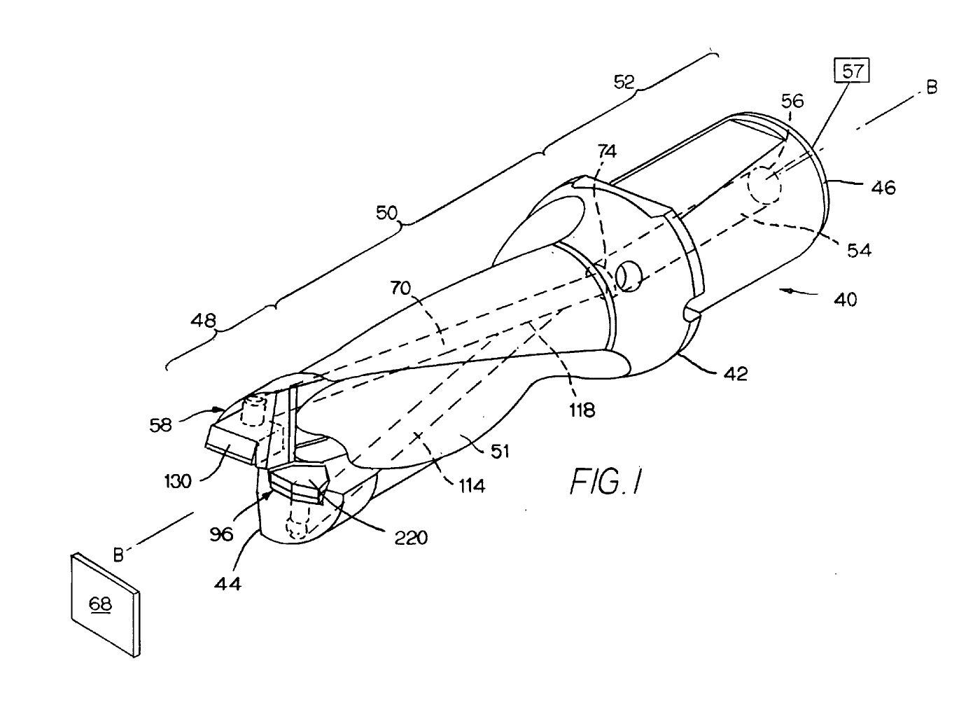

Referring to the drawings, FIG. 1 illustrates a specific embodiment of the indexable drill assembly generally designated as 40 that is useful to cut material (e.g., drill holes) from a workpiece (e.g., low carbon steel, stainless steel, and high temperature alloys) represented in schematic fashion by 68. As will become apparent, the indexable drill assembly 40 has a cutting insert orientation wherein a rectangular-shaped cutting insert is the outboard cutting insert 130 and a trigon (or trigonal) cutting insert is the inboard cutting insert 220. There should be an appreciation that the present invention has application to an indexable drill assembly wherein the outboard cutting insert is a trigon cutting insert and the inboard cutting insert is a rectangular-shaped cutting insert. Further, there should be an appreciation that the present invention has application to an indexable drill assembly that uses two rectangular-shaped cutting inserts wherein each one of the outboard and inboard cutting inserts is rectangular-shaped. Further still, there should be a further appreciation that the present invention has application to an indexable drill assembly that uses two trigon cutting inserts wherein each one of the outboard and inboard cutting inserts is trigonal in shape. The rectangular cutting insert(s) may be of the first specific embodiment cutting insert 130 and/or the second specific embodiment cutting insert 344. Each one of the first specific embodiment rectangular cutting insert 130 and the second specific embodiment rectangular cutting insert 344 are described in more detail hereinafter. The trigon cutting insert is the specific embodiment of the indexable inboard cutting insert 220.

The indexable drill assembly 40 includes an indexable drill body 42 that has a central longitudinal axis B-B. The indexable drill body 42 has an axial forward end 44 and an axial rearward end 46. The indexable drill body 42 has a head portion 48, which is at the axial forward end 44 of the indexable drill body 42, and a shank portion 52, which is at the axial rearward end 46 of the indexable drill body 42. The indexable drill body 42 has a helix portion 50 that is mediate between and contiguous with the head portion 48 and the shank portion 52. Helical flutes 51 extend in an axial orientation along most of the axial length of the helix portion 50. The helical flutes 51 facilitate the evacuation of chips generated during the drilling operation via the cutting inserts (130, 220) cutting the workpiece.

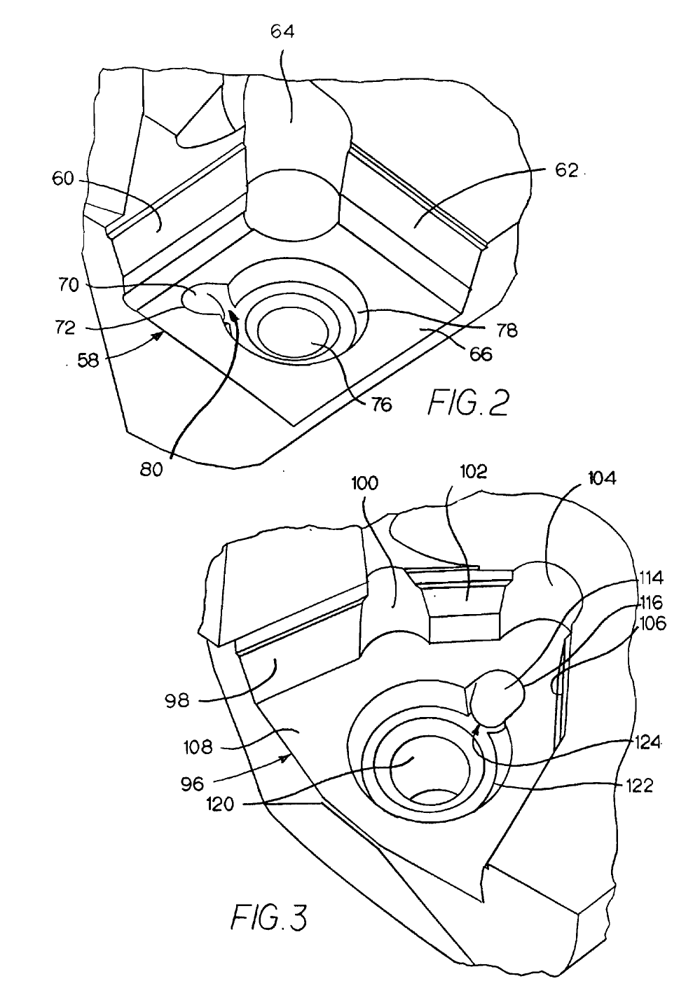

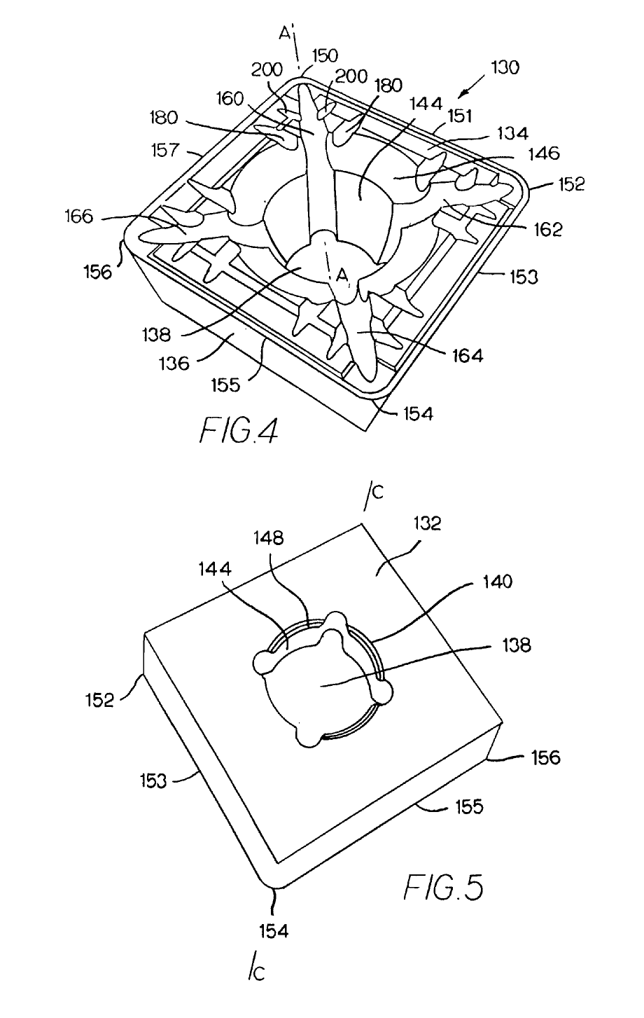

The indexable drill body 42 contains a body coolant channel 54, which is an interior channel, that runs along a portion of the axial length of the helix portion 50 and all of the axial length of the shank portion 52 of the indexable drill body 42. The body coolant channel 54 has an inlet 56 through which coolant (typically under pressure) enters from a coolant source 57. Coolant source 57 is shown in schematic fashion to be in communication with the body coolant channel 54 via inlet 56. The indexable drill body 42 further contains an outboard pocket coolant channel 70 that is in fluid communication with the body coolant channel 54. The outboard pocket coolant channel 70 has a receiving end 74 through which coolant enters from the body coolant channel 54 and a delivery end 72 (see FIG. 2). Coolant passes through the outboard pocket coolant channel 70 exiting the delivery end 72 at the seating surface 66 of the outboard pocket 58. The indexable drill body 42 also contains an inboard pocket coolant channel 114 that is in fluid communication with the body coolant channel 54. The inboard pocket coolant channel 114 has a delivery end 116 and a receiving end 118. The inboard pocket coolant channel 114 receives coolant via the receiving end 118 from the body coolant channel 54. Coolant passes through the inboard pocket coolant channel 114 exiting the delivery end 116 at the seating surface 108 of the inboard pocket 96 (see FIG. 3).

The indexable drill body 42 has an outboard pocket 58 defined by a pair of angularly disposed upstanding walls (60, 62) separated by a notch 64 and a seating surface 66. There is a retention screw aperture 76 in the seating surface 66 wherein there is a generally circular coolant ring 78 in the seating surface 66 adjacent to the retention screw aperture 76. As illustrated in FIG. 2, there is an intersection between the outboard pocket coolant channel 70 at the delivery end 72 and the coolant ring 78 wherein this intersection is generally designated as 80 in FIG. 2. Coolant travels into the coolant ring 78 from the outboard pocket coolant channel 70. As described hereinafter, the coolant ring 78 cooperates with the indexable outboard cutting insert 130 to form an outboard circular coolant conduit 334 that supplies coolant to the outboard cutting insert 130.

The indexable drill body 42 further has an inboard pocket 96 defined by an upstanding wall 98 and another upstanding wall 102 wherein a side notch 100 separates upstanding walls 98 and 102, and still another upstanding wall 106 wherein a central notch 104 separates the upstanding wall 102 from upstanding wall 106. A seating surface 108 further defines the inboard pocket 96. There is a retention screw aperture 120 in the seating surface 108 wherein there is a coolant ring 122 in the seating surface 108 adjacent to the retention screw aperture 120. As illustrated in FIG. 3, there is an intersection between the inboard pocket coolant channel 114 at the delivery end 116 and the coolant ring 122 wherein this intersection is generally designated as 124 in FIG. 3. Coolant travels into the coolant ring 122 from the inboard pocket coolant channel 114. As described hereinafter, the coolant ring 122 cooperates with the indexable inboard cutting insert 220 to form an inboard circular coolant conduit 340 that supplies coolant to the inboard cutting insert 220.

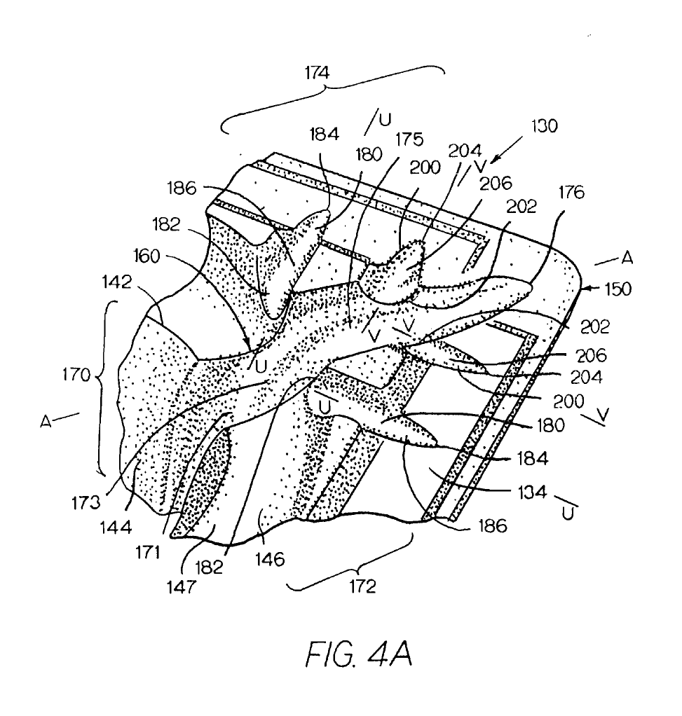

Referring especially to FIGS. 4, 4A and 5, the indexable drill assembly 40 further includes an indexable outboard cutting insert 130, which exhibits a generally rectangular geometry. The outboard cutting insert 130 has an outboard bottom surface 132 and an outboard rake face 134 as well as outboard flank surfaces 136 that join together the bottom surface 132 and the rake face 134. The outboard cutting insert 130 contains an outboard central aperture 138 that has a bottom end 140 and a top end 142 and a side wall 144 with a mouth 146 adjacent to and about the circumference of the top end 142. The mouth 146 has a mouth surface 147. The outboard cutting insert 130 further contains an annular groove 148 about the bottom end 140 of the outboard central aperture 138. The rake face 134 intersects with the flank surfaces 136 to form four discrete outboard corners (150, 152, 154, 156), as well as four discrete outboard cutting edges (151, 153, 155, 157) of the outboard cutting insert 130. As one skilled in the art can appreciate, the outboard cutting insert 130 can be indexed to different positions to present a different selected one of the cutting edges (151, 153, 155, 157) for engagement with the workpiece. Each one of the cutting edges (151, 153, 155, 157) is defined between adjacent discrete corners (150, 152, 154, 156). For example, cutting edge 151 is defined as between discrete corners 150 and 152.

The outboard cutting insert 130 contains four outboard primary coolant troughs 160, 162, 164 and 166 wherein each primary coolant trough corresponds to one of the discrete corners (150, 152, 154, 156), respectively. For the sake of brevity, a description of one primary coolant trough 160 will suffice for the description of the other three primary coolant troughs (162, 164, 166) since the four primary coolant troughs (160, 162, 164, 166) are substantially identical.

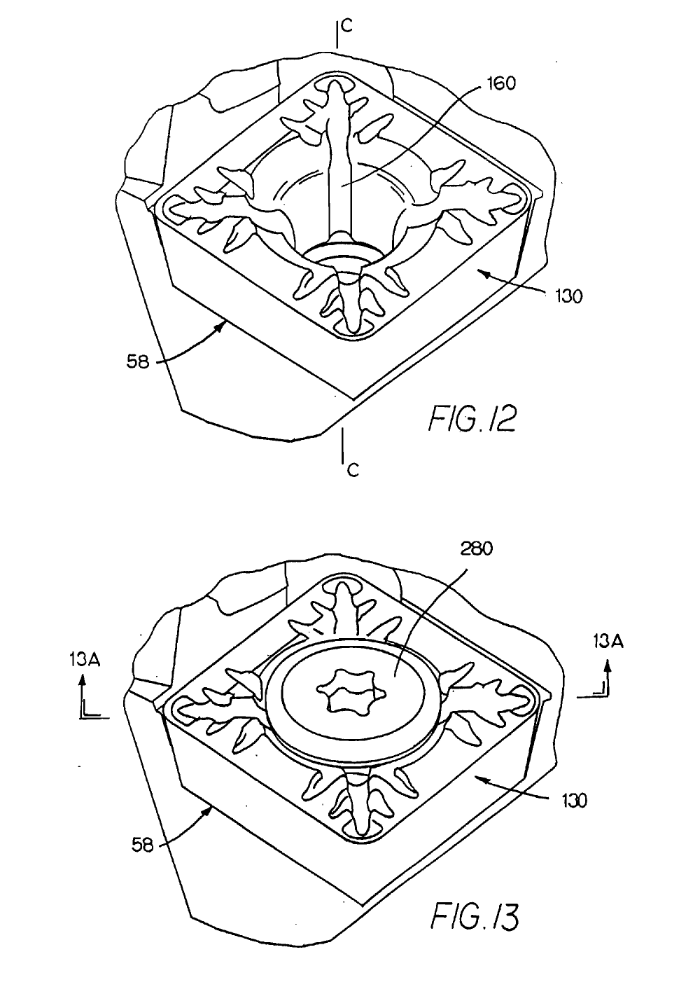

Referring to FIG. 4A, primary coolant trough 160 has an aperture section 170 of the primary coolant trough 160. The aperture section 170 is contained in the side wall 144 of the central aperture 138 and extends from the bottom surface 132 of the outboard cutting insert 130 to the point where the mouth 146 joins the side wall 144. The aperture section 170 has a generally vertical overall orientation in the context of FIG. 4A. The aperture section 170 has an aperture section bottom surface 171 that is generally arcuate in cross-section. The depth of the aperture section 170 remains generally constant along the length thereof. Although the coolant flow will be described hereinafter, there should be an appreciation that coolant flows in an upward direction (generally parallel to the central longitudinal axis C-C of the central aperture 138) (see FIGS. 5 and 12) through a passage defined in part by the aperture section 170 of the primary coolant trough 160.

Still referring to FIG. 4A, primary coolant trough 160 further has a mouth section 172 of the primary coolant trough 160. The mouth section 172 is contained in the mouth 146 and extends between the point where the mouth 146 joins the side wall 144 and the point where the mouth 146 joins the rake face 134. The mouth section 172 is contiguous with the aperture section 170 of the primary coolant trough 160. The general orientation of the mouth section 172 is at an upward angle relative to the orientation of the aperture section 170. The mouth section 172 has a mouth section bottom surface 173. The depth of the mouth section 172 remains generally constant along the length thereof. Although the coolant flow will be described hereinafter, there should be an appreciation that coolant flows from the aperture section 170 into the mouth section 172 wherein the directional orientation of the coolant flow changes to be along the angle of disposition of the mouth section 172 in a radial outward orientation.

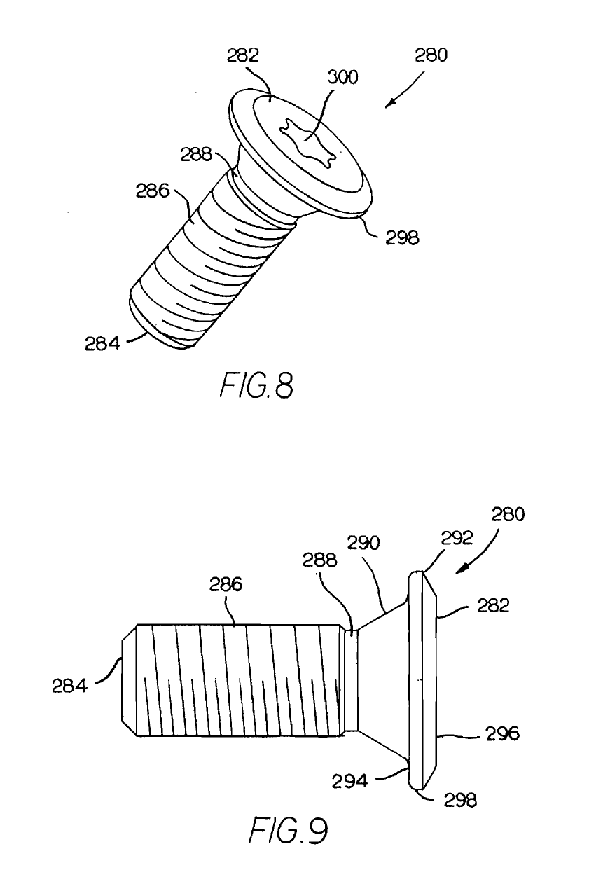

Referring to FIGS. 8 and 9, outboard retention screw 280 has a top end 282 and a bottom end 284 and a threaded portion 286 adjacent to the bottom end 284. A reduced diameter shank portion 288 is axially forward of the threaded portion 286. A frusto-conical portion 290 is axially forward of the reduced diameter shank portion 288, and a head portion 292 is axially forward of the frusto-conical portion 290. Head portion 292 has a rearward facing surface 294, a forward facing surface 296 and a peripheral edge 298. The head portion 292 further contains a screw driver torx reception aperture 300.

Referring to FIGS. 12 and 13, keeping in mind the relative orientation between the primary coolant trough 160 and the outboard retention screw 280, it becomes apparent that the aperture section 170 and the mouth section 172 of the primary coolant trough 160 and at least a portion of the outboard retention screw 280 define there between an outboard primary coolant conduit 302. More specifically, a portion of the outboard primary coolant conduit 302 is defined between the aperture section 170 and threaded portion 286 of the outboard retention screw 280 and another portion of the outboard primary coolant conduit 302 is defined between the mouth section 172 and the frusto-conical portion 290 of the outboard retention screw 280. Referring to FIG. 13A, the coolant is shown by arrows wherein the coolant flows through the outboard primary coolant conduit 302 and through the sections of the primary coolant trough 160 including impinging the outboard retention screw 280. The flow of the coolant is described in more detail hereinafter.

Still referring to FIG. 4A, primary coolant trough 160 also has a rake face section 174 of the primary coolant trough 160. The rake section 174 is contained in the rake face 134. The rake face section 174 extends from the point where the mouth 146 joins the rake face 134 to a point radially inward of the discrete outboard corner 150. The rake face section 174 is contiguous with the mouth section 172. The orientation of the rake face section 174 is generally horizontal wherein the rake face section 174 of the primary coolant trough 160 has a depth that decreases in the radial outward direction. The rake face section 174 has a rake face section bottom surface 175. The depth of the rake face section 174 decreases in the radial outward direction until the rake face section 174 terminates at the exit end 176. This means that as the rake face section 174 moves in the radial outward direction, the rake section bottom surface 175 moves closer to the rake face 134 until it meets the rake face 134 at the exit end 176. Although the coolant flow will be described hereinafter, there should be an appreciation that coolant flows from the mouth section 172 into the rake face section 174 wherein the directional orientation of the coolant flow changes to be in a more generally horizontal direction (i.e., generally parallel to the surface of the rake face 134) toward the corresponding discrete corner 150. However, as the coolant flows toward the exit end 176 it moves in an upward direction away from the rake face 134.

The rake face 134 of the outboard cutting insert 130 contains two angular coolant troughs (180, 200) as described hereinafter. As described hereinafter, each angular coolant trough (180, 200) facilitates the delivery of coolant to the vicinity of the interface between the adjacent cutting edges (153, 157) of the outboard cutting insert 130 and the workpiece.

More specifically, the rake face 134 of the outboard cutting insert 130 contains a pair of radial innermost angular coolant troughs 180, each of which has a central longitudinal axis U-U, wherein a radial innermost angular coolant trough 180 is positioned on each side of the rake face section 174 of the primary coolant trough 160. The radial innermost coolant trough 180 is orientated so the axis U-U is generally perpendicular to the cutting edges. The radial innermost angular coolant troughs 180 are symmetric about a central longitudinal axis A-A (see FIGS. 4 and 4A) through the primary outboard coolant trough 160. Each one of the radial innermost angular coolant troughs 180 has an entrance end 182 and an exit end 184 and an arcuate bottom surface 186. The entrance end 182 opens directly into the mouth 146 so as to directly receive coolant from the mouth 146. Coolant then travels along the length of the radial innermost coolant trough 180 exiting via the exit end 184. Each radial innermost angular coolant trough 180 has a depth that decreases in the radial outward direction, which means that as the arcuate bottom surface 186 moves closer to the rake face 134 until it meets the rake face 134 at the exit end 184. The decrease in depth in the radial outward direction cause the coolant to exit the radial innermost angular coolant trough 180 in a generally upward orientation moving away from the rake face 134 and toward the vicinity of the outboard cutting insert 130-chip interface. As shown in FIG. 4, this would be in the vicinity of the adjacent cutting edges 151 and 157 adjacent corner 150.

The rake face 134 of the outboard cutting insert 130 further contains a pair of radial outermost angular coolant troughs 200, each of which has a central longitudinal axis V-V, wherein a radial outermost angular coolant trough 200 is positioned on each side of the rake face section 174 of the primary coolant trough 160. The radial outermost coolant trough 200 is orientated so the axis V-V is generally perpendicular to the cutting edges. The radial outermost angular coolant troughs 200 are symmetrical about the longitudinal axis A-A of the primary coolant trough 160. The radial outermost angular coolant trough 200 has an entrance end 202 and an exit end 204 and an arcuate bottom surface 206. The entrance end 202 opens into the primary coolant trough 160 so as to directly receive coolant from the primary coolant trough 160. Coolant then travels the length of the radial outermost angular coolant trough 200 exiting via the exit end 204. The radial outermost angular coolant trough 200 has a depth that decreases in the radial outward direction which means that as the arcuate bottom surface 206 moves closer to the rake face 134 until it meets the rake face 134 at the exit end 204. The decrease in depth in the radial outward direction cause the coolant to exit the radial outermost angular coolant trough 200 in a generally upward orientation moving away from the rake face 134 and toward the vicinity of the outboard cutting insert 130-chip interface, which as illustrated in FIG. 4 is in the vicinity of adjacent cutting edges 151 and 157 adjacent corner 150.

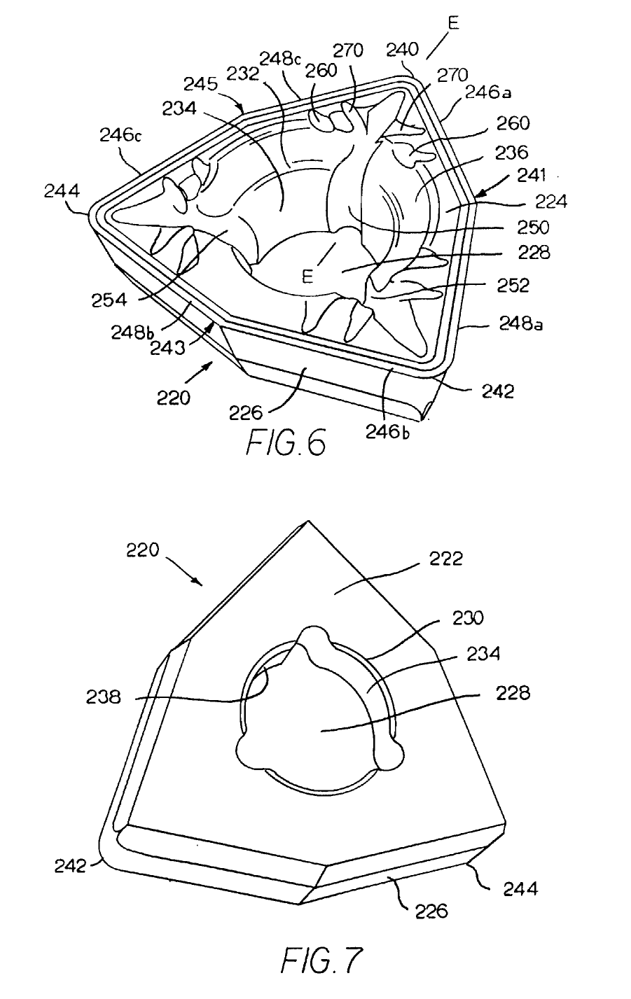

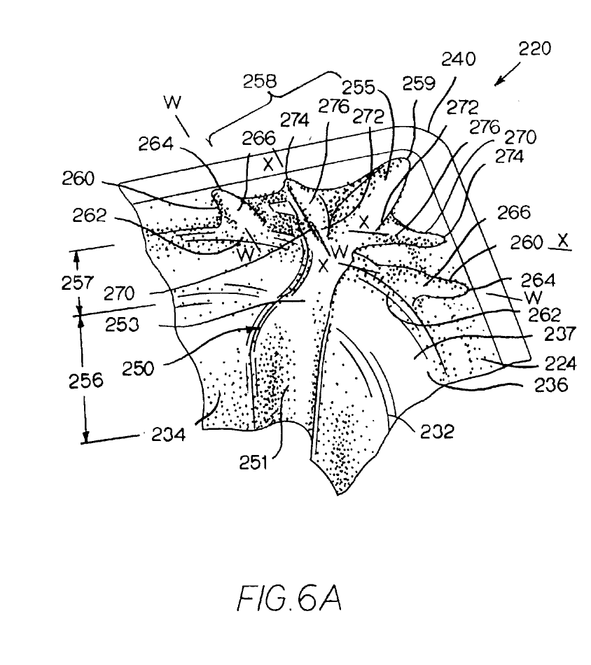

The indexable drill assembly 40 further includes an indexable inboard cutting insert 220, which exhibits a trigon or trigonal geometry. The inboard cutting insert 220, as shown in FIGS. 6, 6A, and 7, has an inboard bottom surface 222 and an inboard rake face 224 as well as inboard flank surfaces 226 that join together the inboard bottom surface 222 and the inboard rake face 224. The indexable inboard cutting insert 220 contains an inboard central aperture 228 that has a bottom end 230 and a top end 232 and a side wall 234 with a mouth 236, which has a mouth surface 237, adjacent to and about the circumference of the top end 232. The inboard central aperture 228 has a central longitudinal axis E-E. The inboard cutting insert 220 further contains an annular groove 238 about the bottom end 230 of the inboard central aperture 228.

The rake face 224 intersects with the flank surfaces 226 to form three discrete inboard corners (240, 242, 244). Inboard cutting insert 220 has three cutting blades (generally designated as 241, 243, 245) wherein each of cutting blades (241, 243, 245) is formed by cutting edges (246a-248c). More specifically, cutting blade 241 is formed by cutting edges 246a and 248a, cutting blade 243 is formed by cutting edges 246b and 248b, and cutting blade 245 is formed by cutting edges 246c and 248c. As one skilled in the art can appreciate, the inboard cutting insert 220 can be indexed to different positions to present a different cutting location for engagement with the workpiece.

The inboard cutting insert 220 contains three primary coolant troughs 250, 252, 254 wherein each primary coolant trough corresponds to one of the discrete inboard corners (240, 242, 244), respectively. For the sake of brevity, a description of one primary coolant trough 250 will suffice for the description of the other two primary coolant troughs (252, 254) since the three primary coolant troughs (250, 252, 254) are substantially identical.

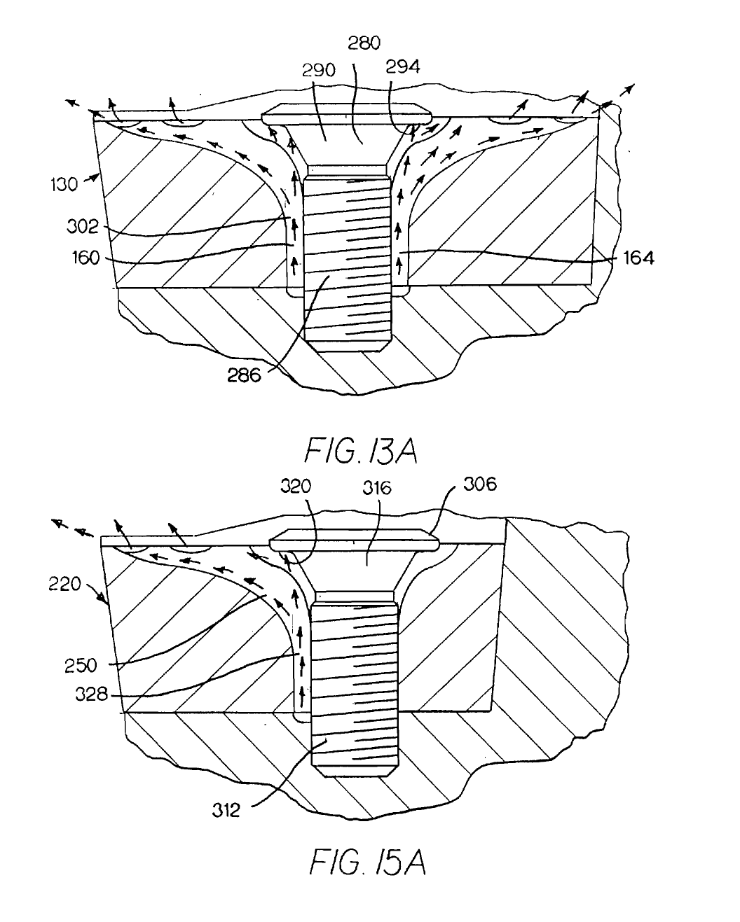

Referring to FIG. 6A, primary coolant trough 250 has an aperture section 256 of the primary coolant trough 250. The aperture section 256 is contained in the side wall 234 of the central aperture 228 and extends from the bottom surface 222 of the inboard cutting insert 220 to the point where the mouth 236 joins the side wall 234. The aperture section 256 has a generally vertical orientation in the context of FIG. 6A. The aperture section 256 has an aperture section bottom surface 251. The depth of the aperture section 256 remains generally constant along the length thereof. Although the coolant flow will be described hereinafter, there should be an appreciation that coolant flows in an upward direction (generally parallel to a central longitudinal axis D-D (see FIG. 14) of central aperture 228) through a passage defined in part by the aperture section 256 of the primary coolant trough 250.

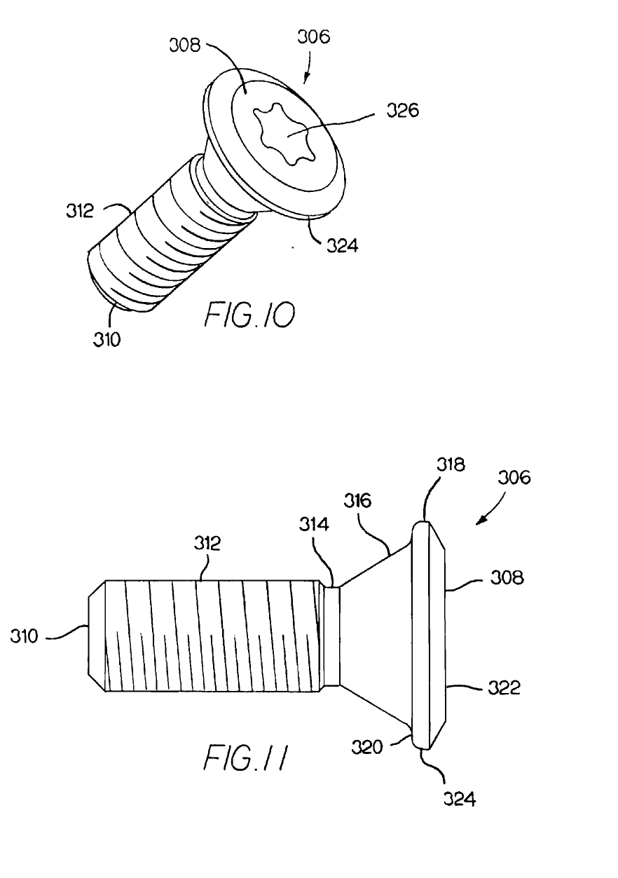

Referring to FIGS. 10 and 11, inboard retention screw 306 has a top end 308 and a bottom end 310 and a threaded portion 312 adjacent to the bottom end 310. A reduced diameter shank portion 314 is axially forward of the threaded portion 312. A frusto-conical portion 316 is axially forward of the reduced diameter shank portion 314, and a head portion 318 is axially forward of the frusto-conical portion 316. Head portion 318 has a rearward facing surface 320, a forward facing surface 322 and a peripheral edge 324. The head portion 318 further contains a screw driver torx reception aperture 316.

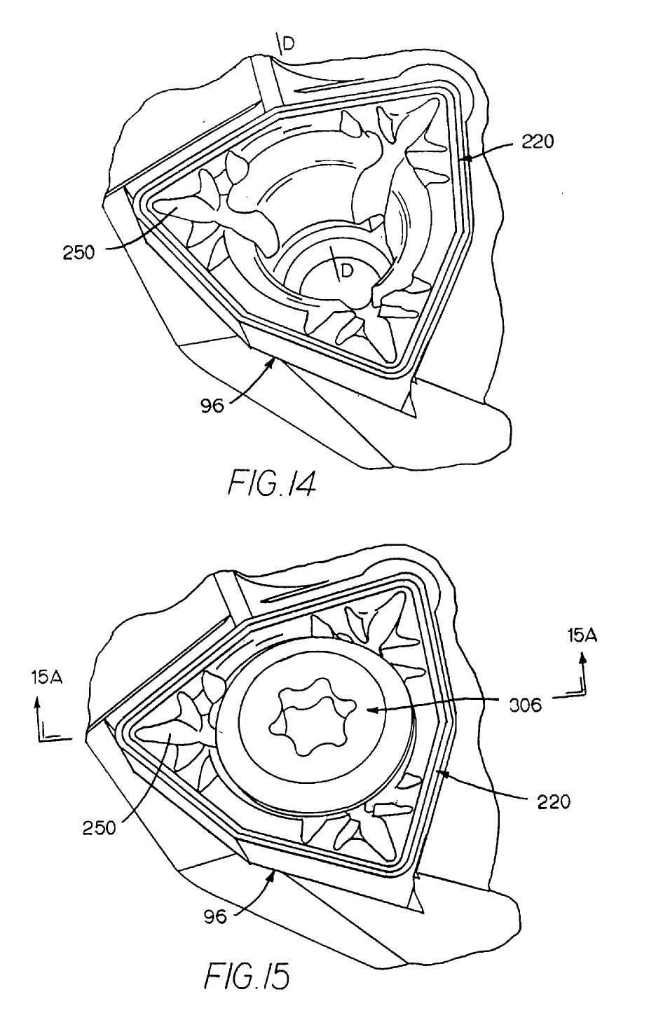

Referring to FIGS. 14 and 15, keeping in mind the relative orientation between the primary coolant trough 250 and the inboard retention screw 306, it becomes apparent that the aperture section 256 and the mouth section 257 of the primary coolant trough 250 and at least a portion of the inboard retention screw 306 define there between an inboard primary coolant conduit 328. More specifically, a portion of the inboard primary coolant conduit 328 is defined between the aperture section 256 and threaded portion 312 of the inboard retention screw 306 and another portion of the inboard primary coolant conduit 328 is defined between the mouth section 257 and the frusto-conical portion 316 of the inboard retention screw 306. Referring to FIG. 15A, the coolant is shown by arrows wherein the coolant flows through the inboard primary coolant conduit 250 and through the sections of the primary coolant trough 250 including impinging the outboard retention screw 306. The flow of the coolant is described in more detail hereinafter.

Still referring to FIG. 6A, primary coolant trough 250 further has a mouth section 257 of the primary coolant trough 250. The mouth section 257 is contained in the mouth 236 and extends between the point where the mouth 236 joins the side wall 234 and the point where the mouth 236 joins the rake face 224. The mouth section 257 is contiguous with the aperture section 256 of the primary coolant trough 250. The overall orientation of the mouth section 257 is at an upward angle relative to the orientation of the aperture section 256. The mouth section 257 has a mouth section bottom surface 253. The depth of the mouth section 257 remains generally constant along the length thereof. Although the coolant flow will be described hereinafter, there should be an appreciation that coolant flows from the aperture section 256 into the mouth section 257 wherein the directional orientation of the coolant flow changes to be along the angle of disposition of the mouth section 257 and in a radial outward direction.

Still referring to FIG. 6A, primary coolant trough 250 also has a rake face section 258 of the primary coolant trough 250. The rake face section 258 is contained in the rake face 224. The rake face section 258 extends from the point where the mouth 236 joins the rake face 224 to a point radially inward of the discrete inboard corner 240. The rake face section 258 is contiguous with the mouth section 257. The rake face section 258 has a rake face section bottom surface 255. The orientation of the rake face section 258 is generally horizontal wherein the rake face section 258 of the primary coolant trough 250 has a depth that decreases in the radial outward direction. The depth of the rake face section 258 decreases in the radial outward direction until the rake face section 258 terminates at the exit end 259. This means that as the rake face section 258 moves in the radial outward direction, the rake face section bottom surface 255 moves closer to the rake face 224 until it meets the rake face 224 at the exit end 259. Although the coolant flow will be described hereinafter, there should be an appreciation that coolant flows from the mouth section 257 into the rake face section 258 wherein the directional orientation of the coolant flow changes to be in a generally horizontal direction (i.e., generally parallel to the surface of the rake face 224) toward the corresponding discrete inboard corner 240. However, as the coolant flows toward the exit end 259 it moves in an upward direction away from the rake face 224.

The rake face 224 of the inboard cutting insert 220 contains two angular coolant troughs (260, 270) as described hereinafter. More specifically, the rake face 224 of the inboard cutting insert 220 contains a pair of radial innermost angular coolant troughs 260, each of which has a central longitudinal axis W-W, wherein a radial innermost angular coolant trough 260 is positioned on each side of the rake face section 258 of the primary coolant trough 250. The radial innermost coolant trough 260 is orientated so the axis W-W is generally perpendicular to the cutting edges. The radial innermost angular coolant trough 260 has an entrance end 262 and an exit end 264 and an arcuate surface 266. The entrance end 262 opens directly into the mouth 236 so as to directly receive coolant from the mouth 236. Coolant then travels along the length of the radial innermost angular coolant trough 260 exiting via the exit end 264. Each radial innermost angular coolant trough 260 has a depth that decreases in the radial outward direction. The decrease in depth in the radial outward direction causes the coolant to exit the radial innermost angular coolant trough 260 in a generally upward orientation moving away from the rake face 224 and toward the vicinity of the inboard cutting insert 220-chip interface. As shown in FIG. 6, this would be in the vicinity of the adjacent cutting edges 246a and 248c.

The rake face 224 of the inboard cutting insert 220 further contains a radial outermost angular coolant trough 270, which has a central longitudinal axis X-X, positioned on each side of the rake face section 258 of the primary coolant trough 250. The radial outermost coolant trough 270 is orientated so the axis X-X is generally perpendicular to the cutting edges. The radial outermost angular coolant trough 270 has an entrance end 272 and an exit end 274 and an arcuate surface 276. The radial outermost angular coolant trough 270 has an entrance end 272 and an exit end 274 and an arcuate bottom surface 276. The entrance end 272 opens into the primary coolant trough 250 so as to directly receive coolant from the primary coolant trough 250. Coolant then travels the length of the radial outermost angular coolant trough 270 exiting via the exit end 274. The radial outermost angular coolant trough 270 has a depth that decreases in the radial outward direction. The decrease in depth in the radial outward direction causes the coolant to exit the radial outermost angular coolant trough 270 in a generally upward orientation moving away from the rake face 224 and toward the vicinity of the inboard cutting insert 220-chip interface, which is illustrated in FIG. 6 as adjacent cutting edges 246a and 248c.

Coolant is supplied, typically under pressure, to the body coolant channel 54 whereby the coolant flows into each one of the outboard pocket coolant channel 70 and the inboard pocket coolant channel 114. Coolant enters the outboard pocket body coolant channel 70 via the receiving end 74 and exits through the delivery end 72 into the vicinity of the outboard pocket 58 so as to flow into the outboard cutting insert 130 as described hereinafter. Coolant in the inboard pocket coolant channel 114 enters via the receiving end 118 and exits through the delivery end 116 into the vicinity of the inboard pocket 96 so as to flow into the inboard cutting insert 220 as described hereinafter.

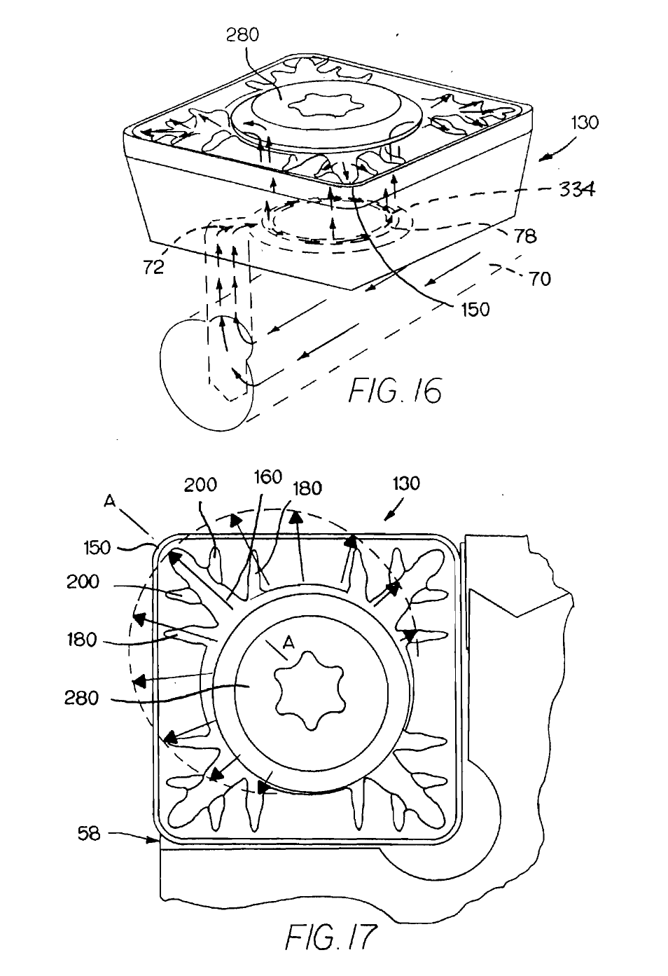

In reference to the flow of coolant into the outboard cutting insert 130 and referring to FIGS. 16 and 17, the coolant exits the outboard pocket coolant channel 70 through the delivery end 72 into the coolant ring 78 that surrounds the retention screw aperture 76. The volume defined by the coolant ring 78 and the annular groove 148 in the bottom surface 132 provides an outboard circular coolant conduit 334 for coolant to flow in a generally circular fashion. This generally circular flow pattern is shown in a schematic fashion in FIG. 16. Coolant then flows through the outboard circular coolant conduit 334 and into the primary coolant troughs 160, 162, 164, 166 in the outboard cutting insert 130. Further, the orientation of the primary coolant troughs (160, 162, 164, 166) can be such so that coolant directly enters the primary coolant troughs (160, 162, 164, 166). Although the description uses the terminology associated with the primary coolant troughs (160, 162, 164, 166), there should be an appreciation that the outboard retention screw 280 and each of the primary coolant troughs 160, 162, 164, 166 defines a volume that is a conduit in which coolant flows.

Referring to primary coolant trough 160 (which applied to the other primary coolant troughs 162, 164, 166), coolants flows into the primary coolant trough 160 so as to pass through the aperture section 170. Some of the coolant then impinges on the rearward facing surface 294 of the head portion 292 and is directed to pass through the mouth section 172 and then flow into the rake face section 174 of the primary coolant trough 160. Further, some of the coolant flows into the entrance end 182 of each one of the radial innermost angular coolant troughs 180 and out of the exit end 184 thereof. Some of the coolant flows into the entrance end 202 of each of the radial outermost angular coolant troughs 200 and out of the exit end 204 thereof. Some of the coolant flows completely through the primary coolant trough 160 exiting at the exit end 176 thereof. As described hereinabove, the coolant exiting the rake face section 174 and the radial innermost angular coolant trough 180 and the radial outermost angular coolant trough 200 travels in a direction generally away from the rake face 134.

The outboard retention screw 280 exerts a so-called “pull back” on the outboard cutting insert 130 so as to pull the outboard cutting insert 130 into the outward pocket 58. Thus, the volume of coolant entering those primary coolant troughs is greater for the primary coolant troughs farther away from the notch 64 that separates the upstanding walls 60 and 62 as compared to the primary coolant troughs closer to the notch 64. More specifically, the outboard retention screw 280 provides for a “pull back” feature upon complete tightening into the retention screw aperture 76. The outboard retention screw 280 accomplishes this feature by a difference in the orientation of the longitudinal axis of the threaded portion 286 as compared to the longitudinal axis of the remainder of the outboard retention screw 280. This feature is shown and described in issued U.S. Pat. No. 8,454,274 to Chen et al. (assigned to the assignee of the present patent application), which is hereby incorporated by reference herein. This difference in coolant volume flow is shown in FIG. 17 wherein the longer arrows represent a greater coolant volume. In this regard, one sees that the greatest coolant flow is through primary coolant trough 160, which is opposite the notch 64, and the least, if any, coolant flow is through primary coolant trough 164. Moderate coolant flow is through primary coolant troughs 162 and 166. This feature allows for more efficient delivery of coolant in that a greater volume of coolant reaches the cutting insert-chip interface (e.g., more coolant is directed to the drill corner point).

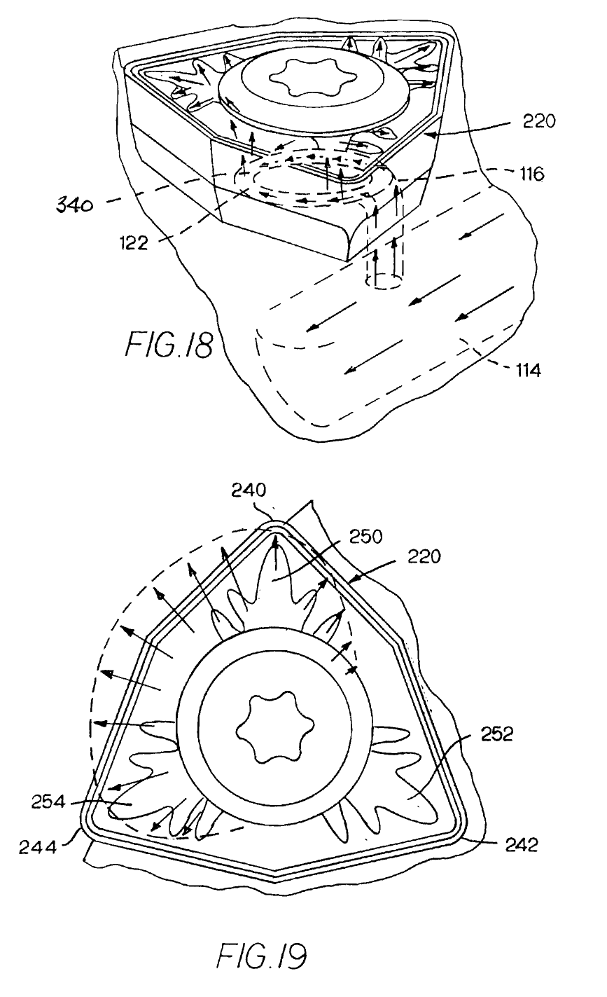

In reference to the flow of coolant into the inboard cutting insert 220 and referring to FIGS. 18 and 19, the coolant exits the inboard pocket coolant channel 114 through the delivery end 116 into the coolant ring 122 that surrounds the retention screw aperture 120. The volume defined by the coolant ring 122 and the annular groove 238 in the bottom surface 222 provides an inboard circular coolant conduit 340 for coolant to flow in a generally circular fashion. This generally circular flow pattern is shown in a schematic fashion in FIG. 18. Coolant then flows through the inboard circular coolant conduit 340 and into the primary coolant troughs 250, 252, 254 in the inboard cutting insert 220. Further, the orientation of the primary coolant troughs (250, 252, 254) can be such that coolant directly enters the primary coolant troughs (250, 252, 254). Although the description uses the terminology associated with the primary coolant troughs (250, 252, 254), there should be an appreciation that the outboard retention screw 306 and each of the primary coolant troughs (250, 252, 254) defines a volume (or conduit) through which coolant flows.

Referring to primary coolant trough 250 (which applied to the other primary coolant troughs 252, 254), coolant flows into the primary coolant trough 250 so as to pass through the aperture section 256. Some of the coolant then impinges on the rearward facing surface 320 of the head portion 318 of the inboard retention screw 306 and is directed to pass through the mouth section 257 and then flow into the rake face surface section 258 of the primary coolant trough 250. Coolant flows out of the rake face section 258 at the exit end 259. Further, some of the coolant flows into the entrance end 262 of each one of the radial innermost angular coolant troughs 260 and out of the exit end 264 thereof. Some of the coolant flows into the entrance end 272 of each of the radial outermost angular coolant troughs 270 and out of the exit end 274 thereof. Some of the coolant flows completely through the primary coolant trough 250 exiting at the exit end 259 thereof. As described hereinabove, the coolant exiting the rake face section 258 and the radial innermost angular coolant trough 260 and the radial outermost angular coolant trough 270 travels in an upward direction away from the rake face 224.

The inboard retention screw 306 exerts a so-called “pull back” on the inboard cutting insert 220 so as to pull the inboard cutting insert 220 into the inboard pocket 96. Thus, the volume of coolant entering the primary coolant troughs is greater for the primary coolant troughs farther away from the central notch 104 that separates the upstanding walls 102 and 106. More specifically, the inboard retention screw 306 provides for a “pull back” feature upon complete tightening into the retention screw aperture 120. The outboard retention screw 306 accomplishes this feature by a difference in the orientation of the longitudinal axis of the threaded portion 312 as compared to the longitudinal axis of the remainder of the inboard retention screw 306. This feature is shown and described in issued U.S. Pat. No. 8,454,274 to Chen et al. (assigned to the assignee of the present patent application) which is hereby incorporated by reference herein. This difference in coolant volume flow is shown in FIG. 19 wherein the longer arrows represent a greater coolant volume. In this regard, one sees that the greater coolant flow is through primary coolant troughs 250 and 254, and the least, if any, coolant flow is through primary coolant trough 252. This feature allows for more efficient delivery of coolant in that a greater volume of coolant reaches the cutting insert-chip interface (e.g., more coolant is directed to the drill corner point).

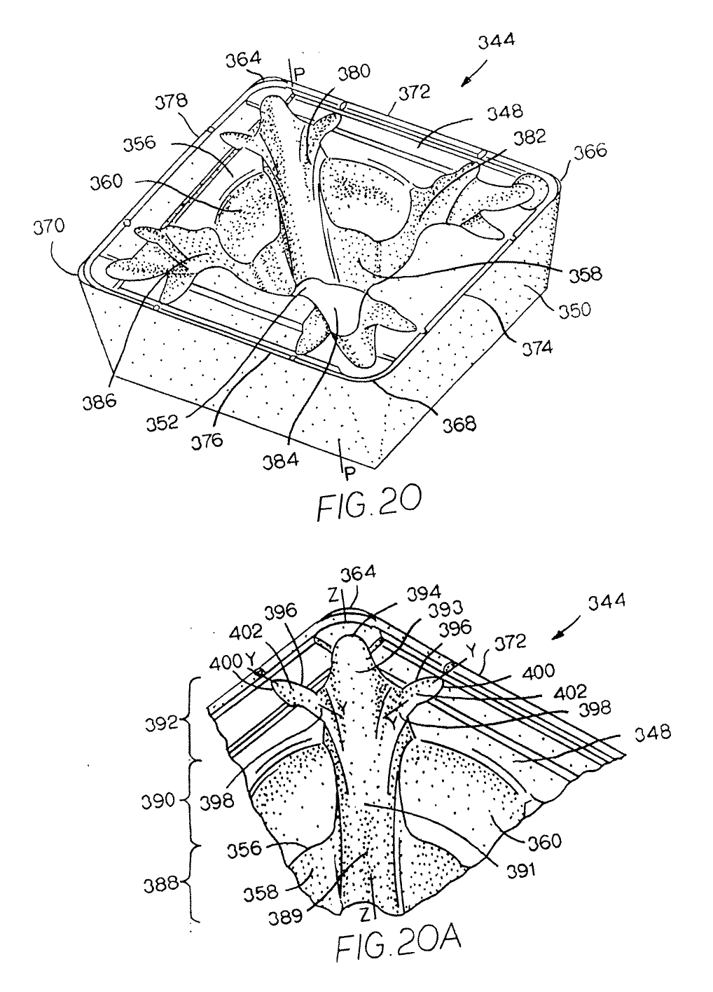

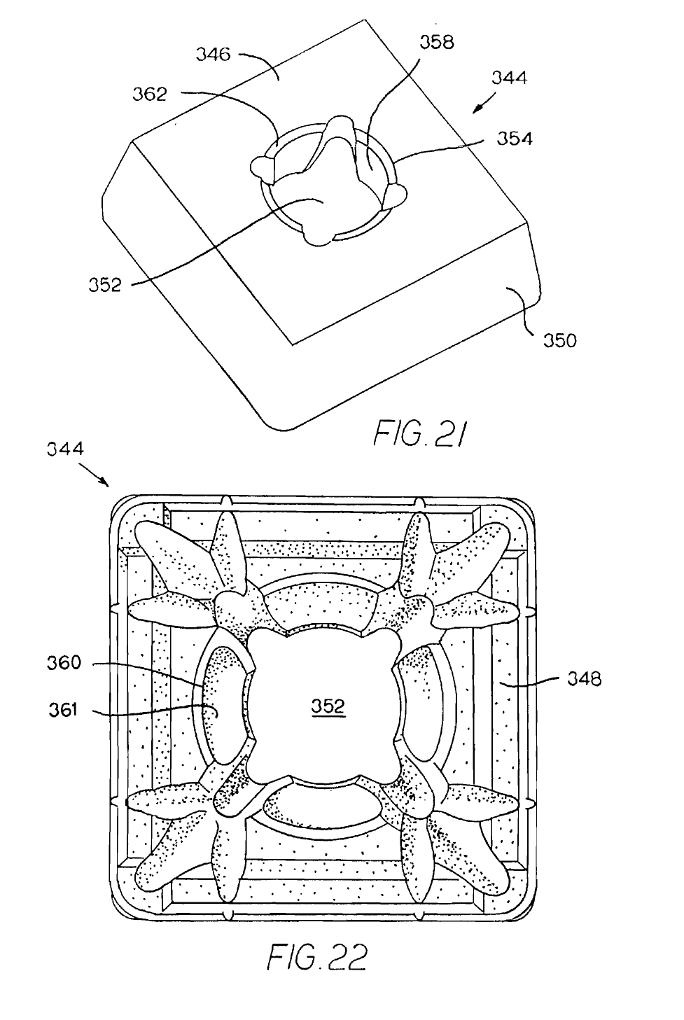

Referring to FIGS. 20 through 22, there is shown another specific embodiment of an indexable cutting insert generally designated as 344, which exhibits a generally rectangular geometry. The indexable cutting insert 344 has a bottom surface 346 and a rake face 348 as well as flank surfaces 350 that join together the bottom surface 346 and the rake face 348. The indexable cutting insert 344 contains a central aperture 352 that has a bottom end 354 and a top end 356 and a side wall 358 with a mouth 360, which has a mouth surface 361, adjacent to and about the circumference of the top end 356. The indexable cutting insert 344 further contains an annular groove 362 about the bottom end 354 of the central aperture 352. The rake face 348 intersects with the flank surfaces 350 to form four discrete corners (364, 366, 368, 370), as well as four discrete cutting edges (372, 374, 376, 378) of the indexable cutting insert 344. Each cutting edge (372, 374, 376, 378) is defined between adjacent corners (364, 366, 368, 370). For example, cutting edge 372 is defined between corners 364 and 366. As one skilled in the art can appreciate, the indexable cutting insert 344 can be indexed to different positions to present a different selected one of the cutting edges (372, 374, 376, 378) for engagement with the workpiece.

The indexable cutting insert 344 contains four primary coolant troughs (380, 382, 384 and 386) wherein each primary coolant trough (380, 382, 384 and 386) corresponds to one of the discrete corners (364, 366, 368, 370), respectively. For the sake of brevity, a description of one primary coolant trough 380 will suffice for the description of the other three primary coolant troughs (382, 384, 386) since the four primary coolant troughs (380, 382, 384 and 386) are substantially identical. Primary coolant trough 380 has a central longitudinal axis Z-Z.

Referring to FIG. 20A, primary coolant trough 380 has an aperture section 388 of the primary coolant trough 380. The aperture section 388 is contained in the side wall 358 of the central aperture 352 and extends from the bottom surface 346 of the indexable cutting insert 344 to the point where the mouth 360 joins the side wall 358. The aperture section 388 has a generally vertical orientation in the context of FIG. 20A. The aperture section 388 has an aperture section bottom surface 389. The depth of the aperture section 388 remains generally constant along the length thereof. Although the coolant flow will be described hereinafter, there should be an appreciation that coolant flows in an upward direction (generally parallel to the central longitudinal axis P-P of the central aperture 352) through a passage defined in part by the aperture section 388 of the primary coolant trough 380.

Still referring to FIG. 20A, primary coolant trough 380 has a mouth section 390 of the primary coolant trough 380. The mouth section 390 is contained in the mouth 360 and extends between the point where the mouth 360 joins the side wall 358 and the point where the mouth 360 joins the rake face 348. The mouth section 390 is contiguous with the aperture section 388 of the primary coolant trough 380. The orientation of the mouth section 390 is at an upward angle relative to the orientation of the aperture section 388. The mouth section 388 has a mouth section bottom surface 391. The depth of the mouth section 390 remains generally constant along the length thereof. Although the coolant flow will be described hereinafter, there should be an appreciation that coolant flows from the aperture section 388 into the mouth section 390 wherein the directional orientation of the coolant flow changes to be generally along the angle of disposition of the mouth section 390 in a radial outward orientation.

Still referring to FIG. 20A, primary coolant trough 380 has a rake face section 392 of the primary coolant trough 380. The rake face section 392 is contained in the rake face 348. The rake face section 392 extends from the point where the mouth 360 joins the rake face 348 to a point radially inward of the discrete corner 364. The rake face section 392 is contiguous with the mouth section 390. The rake face section 392 has a rake face section bottom surface 393. The orientation of the rake face section 392 is generally horizontal wherein the rake face section 392 of the primary coolant trough 380 has a depth that decreases in the radial outward direction. Although the coolant flow will be described hereinafter, there should be an appreciation that coolant flows from the mouth section 390 into the rake face section 392 wherein the directional orientation of the coolant flow changes to be in a more generally horizontal direction (i.e., generally parallel to the surface of the rake face 348) toward the corresponding discrete corner 364. However, as the coolant flows toward the exit end 394 it moves in an upward direction away from the rake face 348.

The rake face 348 of the indexable cutting insert 344 contains angular coolant troughs 396 as described hereinafter. Each angular radial coolant trough 396, which has a central longitudinal axis Y-Y, facilitates the delivery of coolant to the vicinity of the interface between the adjacent cutting edges (374, 376) of the indexable cutting insert 344 and the workpiece. The angular coolant trough 396 is orientated so the axis Y-Y is generally perpendicular to the cutting edges.

More specifically, the rake face 348 of the indexable cutting insert 344 contains a pair of angular coolant troughs 396 positioned on each side of the rake face section 174 of the primary coolant trough 382. The angular coolant trough 396 is symmetric about a central longitudinal axis Z-Z through the primary coolant trough 382. The angular coolant troughs 396 each have an entrance end 398 and an exit end 400 and an arcuate surface 402. The entrance end 398 opens into the mouth 360 so as to receive coolant from the mouth 360. Coolant then travels along the length of the angular coolant trough 396 exiting via the exit end 400. The angular coolant trough 396 has a depth that decreases in the radial outward direction. The decrease in depth in the radial outward direction cause the coolant to exit the angular coolant trough 396 in a generally upward orientation moving away from the rake face 348 and toward the vicinity of the indexable cutting insert 344-chip interface, which is in the vicinity of the cutting edges 372, 378. The coolant exiting the rake face section 392 and the radial angular coolant trough 396 travels in an upward direction away from the rake face 348.

The present invention provides an indexable cutting insert with a coolant delivery feature. The indexable cutting insert, which provides the coolant delivery feature, is suitable for use in a drill body of an indexable drill assembly, which is useful for the drilling of holes in a workpiece. The indexable cutting insert, which is suitable for use in a drill body of the indexable drill assembly, is adapted to facilitate enhanced delivery of coolant adjacent the interface between the workpiece and the indexable cutting insert (insert-chip interface). The delivery of coolant provides cooling thereby diminishing tremendous heat and also providing lubrication at the insert-chip interface in an operation such as, for example, a hole drilling operation. By diminishing the heat, the present invention is able to reduce excessive heat at the insert-chip interface to eliminate or reduce build up of chip material. By diminishing the heat, the present invention will facilitate the evacuation of chips from the insert-chip interface thereby minimizing the potential that a chip will be re-cut during the drilling operation.

The patents and other documents identified herein are hereby incorporated by reference herein. Other embodiments of the invention will be apparent to those skilled in the art from a consideration of the specification or a practice of the invention disclosed herein. It is intended that the specification and examples are illustrative only and are not intended to be limiting on the scope of the invention. The true scope and spirit of the invention is indicated by the following claims.

What is claimed is:

1. An indexable cutting insert comprising:
a rake face, a flank surface, and a bottom surface, and the indexable cutting insert containing a central aperture having a top aperture end and being defined by an aperture side wall, and the indexable cutting insert further having a mouth defined by a mouth surface;
a primary coolant trough, the primary coolant trough having an aperture section contained in the aperture side wall and the aperture section having an aperture section bottom surface, a mouth section contained in the mouth surface and the mouth section having a mouth section bottom surface, and a rake face section contained in the rake face and the rake face section having a rake face section bottom surface; and
a radial angular coolant trough having an entrance end, the entrance end opening into a selected one of the primary coolant trough or the mouth; and
the radial angular coolant trough having a central longitudinal axis, and the radial angular coolant trough having an orientation wherein the central longitudinal axis thereof being generally perpendicular to a corresponding discrete cutting edge whereby during operation a coolant stream is directed from the radial angular coolant trough toward the corresponding discrete cutting edge.

2. The indexable cutting insert according to claim 1 wherein the radial angular coolant trough being a radial innermost angular coolant trough having an entrance end opening into the mouth.

3. The indexable cutting insert according to claim 2 further including a radial outermost angular coolant trough having an entrance end opening into the primary coolant trough, and the radial outermost angular coolant trough having a central longitudinal axis, and the radial innermost angular coolant trough having an orientation wherein the central longitudinal axis thereof being generally perpendicular to the corresponding discrete cutting edge whereby during operation a second coolant stream is directed from the radial outermost angular coolant trough toward the corresponding discrete cutting edge.

4. The indexable cutting insert according to claim 1 wherein the aperture section has a orientation wherein the aperture section bottom surface being generally parallel to a central longitudinal axis of the central aperture, the mouth section having an orientation wherein the mouth section bottom surface being disposed at an angle with respect to the aperture section bottom surface.

5. The indexable cutting insert according to claim 4 wherein the rake face section having a depth decreasing in the radial outward direction, and a depth of the aperture section being generally constant along the axial length thereof, and the depth of the mouth section being generally constant along the axial length thereof.

6. The indexable cutting insert according to claim 1 wherein the indexable cutting insert being rectangular.

7. The indexable cutting insert according to claim 1 wherein the indexable cutting insert being trigon-shaped.

8. The indexable cutting insert according to claim 1 further including at least a pair of adjacent discrete corners and wherein the discrete cutting edge being defined between the adjacent discrete corners, and a plurality of the angular radial coolant troughs wherein one of the angular radial coolant troughs corresponding to one of the adjacent discrete corners, each of the angular radial coolant troughs being oriented toward the corresponding discrete cutting edge whereby during operation a plurality of coolant streams being directed from the angular radial coolant troughs toward the corresponding discrete cutting edge.

9. The indexable cutting insert according to claim 1 further containing a plurality of second angular radial coolant troughs wherein one of the second angular radial coolant troughs corresponding to one of the adjacent discrete corners, each of the second angular radial coolant troughs being oriented toward the corresponding discrete cutting edge whereby during operation a plurality of the coolant streams being directed from the second angular radial coolant troughs toward the discrete cutting edge.

10. An indexable cutting insert adapted to be retained in a pocket having a seating surface of an indexable drill body wherein the indexable drill body contains a pocket coolant channel opening at the seating surface, the indexable drill body further containing a retention screw aperture opening in the seating surface, and the seating surface containing a coolant ring surrounding the retention screw aperture wherein the coolant ring being in fluid communication with the pocket coolant channel, and the indexable cutting insert comprising:
a rake face, a flank surface, and a bottom surface, and the indexable cutting insert containing a central aperture having a central aperture bottom end; and
the indexable cutting insert further containing an annular groove in the bottom surface surrounding the central aperture adjacent the central aperture bottom end, and the annular groove cooperating with the coolant ring to form a circular coolant conduit through which coolant flows from the pocket coolant channel to the indexable cutting insert.

11. The indexable cutting insert according to claim 10 further including a primary coolant trough, a mouth, and a radial angular coolant trough having an entrance end, the entrance end opening into a selected one of the primary coolant trough or the mouth.

12. The indexable cutting insert according to claim 11 wherein the radial angular coolant trough being a radial innermost angular coolant trough having an entrance end opening into the mouth.

13. The indexable cutting insert according to claim 12 further including a radial outermost angular coolant trough having an entrance end opening into the primary coolant trough.
